(19) United States
(12) Patent Application Publication
(10) Pub. No.: US 2006/0238293 A1
(43) Pub. Date: Oct. 26, 2006

(54) Power control system

(76) Inventor: Charles A. Mirho, Vancouver, WA (US)

Correspondence Address: FSP LLC;Attn: Charles A. Mirho, P.O. Box 890, Vancouver, WA, 98666, US

(21) Appl. No.: 11/114,574

(22) Filed: Apr. 25, 2005

(51) Int. Cl. G05B 19/00

(52) U.S. Cl. 340/5.2; 340/5.61

(57) ABSTRACT

A system includes logic to receive information about one or more parties, logic to communicate the information to decision logic via a power transmission path, and logic to receive, via the power transmission path, one or more indications that power should be transmitted from one or more power sources to one or more devices coupled to the power sources.

### TECHNICAL FIELD

The present disclosure relates to device power access and management.

### BACKGROUND

Various devices may be located in areas accessible to a variety of people. It may be desirable to restrict access to certain devices to certain people. Thus, a problem arises when people who should not be using a device may nonetheless access the device.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

In one embodiment, an apparatus includes a receptacle to receive a power plug, a lock to secure the power plug, a power input, and logic to selectively transfer power from the power input to the receptacle. The apparatus may include logic to receive an indication via a power transmission path to enable transfer of power from the power input to the receptacle. The apparatus may include logic to receive information about one or more parties, logic to selectively authorize the one or more parties, and logic to enable transmission of power from the power input to the receptacle in response to authorization of the one or more parties. The apparatus may include logic to receive information about one or more parties and logic to communicate the party information via the power interface to decision logic, the decision logic providing an indication to the apparatus as to whether or not to enable the transmission of power from the power input to the receptacle.

In one embodiment, a system includes logic to receive information about one or more parties, logic to communicate the information to decision logic via a power transmission path, and logic to receive, via the power transmission path, one or more indications that power should be transmitted from one or more power sources to one or more devices coupled to the power sources. The system may include a detector to detect the party information and to communicate the party information to the decision logic via a power transmission path. The system may include logic to determine at least one devices and/or power sources proximate to the one or more parties and/or belonging to a same group or groups and/or having one or more similar attributes, logic to authorize the one or more parties to operate the at least one devices, or not, and logic to cause power sources for the at least one devices to be enabled, or not, according to the authorizations. The system may include logic to communicate via the power transmission path indications that enable power to be transmitted from power sources to devices coupled to the power sources.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for case of understanding and convenience. To easily identify the discussion of any particular element or act, the most significant digit or digits in a reference number refer to the figure number in which that element is first introduced.

FIG. 1 is a block diagram of an embodiment of a power control system.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to affect the operation of a device. Software, hardware, and firmware are examples of logic. Hardware logic may be embodied in circuits. In general, logic may comprise combinations of software, hardware, and/or firmware.

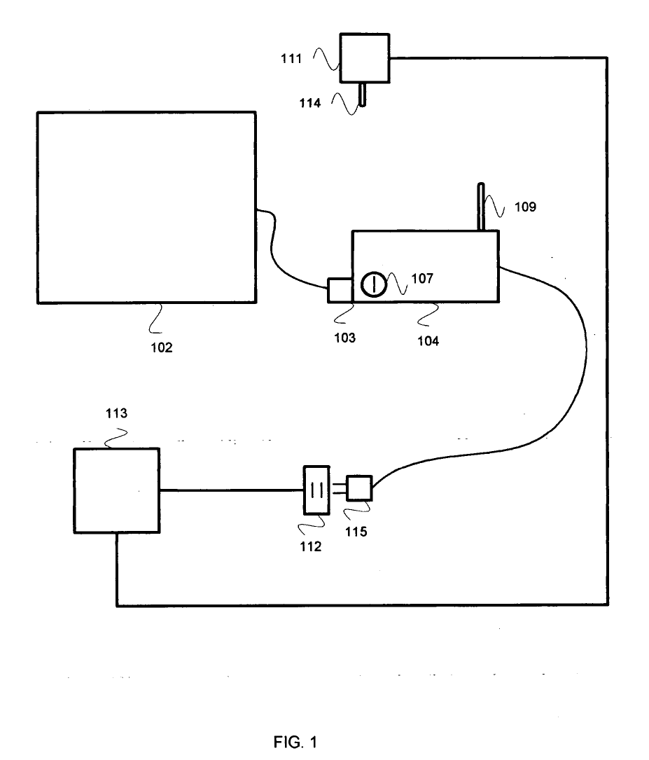

FIG. 1 is a block diagram of an embodiment of a power control system. A device 102 has a power plug 103. The power plug 103 is plugged into the power controlling component 104, which comprises a receptacle to receive the power plug 103. The power controlling component 104 comprises a locking mechanism 107. The power controlling component 104 also comprises functionality, shown embodied herein as an antenna 109, to enable electronic communications between its logic and other physical things, such as devices or other potentially communicating entities. For example, the antennae could enable wireless communication with a smart card, ring, or other RFID (radio frequency ID) or short-range wireless device (e.g. Bluetooth, Wi-Fi, or Wi-Max device) comprising personal identity information. The power controlling component could also communicate with such devices via wires, or via contact.

The locking mechanism 107 may be locked and/or unlocked mechanically. For example, locking and/or unlocking may occur with use of a physical key. The locking mechanism 107 may also/alternatively be locked and/or unlocked electronically, e.g. via a keypad or other electronic technique. The locking mechanism 107 may unlock selectively, according to the identity of a person attempting to access the device 102.

Both a physical and an electronic mechanism may be involved in locking and/or unlocking the locking mechanism 107. Additionally or alternatively, the locking mechanism 107 might support either mechanism for either locking or unlocking or both. As an example of supporting both mechanisms for locking or unlocking, the locking mechanism 107 might accept a physical key which can be used to lock or unlock the power receptacle of the power controlling component 104. The lock/unlock logic of the power controlling component 104 may also lock or unlock the device based on an electronic signal.

The same mechanisms may not be implemented for locking and unlocking. For example, in some embodiments, locking may always require, at least in part, a mechanical component such as insertion of a key. However, in those same embodiments, unlocking might be accomplished either with use of the mechanical component (key insertion) or without it via an electronic signal.

In some embodiments, when the plug 103 is inserted into the receptacle of the power controlling component 104, locking will be performed “automatically” by the locking mechanism 107. In other embodiments, a separate action, such as for example inserting a key, will have to occur to accomplish locking.

The locking mechanism 107 may physically secure the device plug 103 when it is in a locked position so that the device plug 103 cannot be removed from its receptacle in the power controlling component 104.

The power controlling component 104 comprises a power interface, e.g. a power input, shown in this embodiment as a plug 15. The plug 115 is inserted into a power receptacle 112, from which the power controlling device 104 obtains its power input. In some situations (not shown), the power receptacle 112 may itself be a part of a power plug (e.g. an extension cord or power strip).

The power controlling device 104 may selectively transfer power from the power interface 115 to the power plug 103, by controlling the receipt of power to the receptacle to which the power plug 103 is inserted, and thus to the device 102.

In some embodiments, the power plug 103 may selectively receive power only when the locking mechanism 107 is in the locked position. In some embodiments, the power plug 103 may selectively receive power when the locking mechanism 107 is in both the locked and the unlocked position. In some embodiments, the power plug 103 may always receive power (e.g. regardless of the person attempting to access the device 102) when the locking mechanism 107 is in the unlocked position.

The power control system comprises decision logic 113 to determine whether the power controlling mechanism 104 should provide power to the power plug 103 or not. The power decision logic 113 communicates with the power controlling mechanism 104, providing an indication to enable transfer of power from the power interface 115 to the power plug 103.

In some embodiments, the decision logic 113 and the power controlling mechanism 104 are embodied within the same device. For example, the decision logic 113 may be implemented as circuits and/or software within the power controlling mechanism.

In some embodiments, the decision logic 113 and the power controlling mechanism 104 are implemented within distinct devices, which may be located close to each other (within a single room or a single building, for example), or even farther apart (e.g. a the decision logic 113 is implemented as part of a more distant central power control center).

Regardless of location, the decision logic 113 may control one or several power controlling mechanism 104 devices, or may be particular to one or a group of such devices. Also regardless of location, the decision logic 113 may be configured to determine which persons should have access to which devices. Such configuration may take place locally (e.g. via a keypad, keyboard, mouse, voice interface, or other user interface local to the decision logic 113, or remotely via network signals to the decision logic 113).

The decision logic 113 may communicate with the power controlling mechanisms 104 over a network. The network may comprise a local area network, an intranet, the Internet, or more than one of these. The decision logic 113 may be provided as a service with power controlling mechanisms 104 being used in the homes and or within business establishments/corporations.

The decision logic 113 may communicate wirelessly with the power controlling mechanism 104, and the power controlling mechanism 104 may comprise logic to receive a wireless indication to enable transfer of power from the power interface 115 to the power plug 103.

In some embodiments, the decision logic 113 and the power controlling mechanism 104 communicate via the power transmission path (e.g. power transmission lines within and/or external to the structure housing the system, such as home and/or office wiring and/or the serving power grid). So-called BPL (broadband over power lines) technology, HomePlug, and HPAS (Home Powerline Alliance Standard) are examples of technologies that may be applicable in these embodiments. The power controlling mechanism 104 may comprise logic to receive, via the power transmission path, an indication to enable transfer of power from the power interface 115 to the power plug 103.

In some embodiments, a detector 111 having an antenna 114 and/or other sensor may be co-located (e.g. located proximate to and/or in the same room with) various devices to which access is to be controlled. The detector 111 operates to detect the presence of a person in the area of the device 102. This may involve detecting an RFID or other identification that the person carries around.

In some embodiments, the detector 111 and decision logic 113 may be implemented within one device. The detector 11 and sensor 114 may be part of the same device, or the sensor 114 may be a remote sensor 114 having some mechanism for communicating with the detector 111 (e.g. wirelessly, or via dedicated network wires, or via power lines).

In some embodiments, the detector 111, power controlling mechanism 104, and decision logic 113 may all be implemented within one device. That one device may also incorporate the sensor 114, or the sensor 114 may be a remote sensor. In these embodiments, the device is essentially “stand-alone”, as it may make and implement the decisions to lock/unlock the receptacle to which the plug 103 is inserted or to provide/withhold power to that receptacle without communicating with another power control system component (except perhaps the sensor 114, if remote).

In some embodiments, as previously indicated, the power controlling mechanism 104, the decision logic 113, and the detector 111 will be in some combination partially or completely distinct (e.g. not part of the same device).

The sensor 114 receives information about one or more individuals proximate to, or who may wish to use (e.g. obtain power to) or unlock (and thus potentially unplug or move) the device, 102 and/or other devices in the area. This information may be obtained wirelessly (e.g. RFID or Bluetooth), or via a network (e.g. the power lines, Ethernet, etc,), or via a bus or other communication technology (e.g. USB, Universal Serial Bus), or via contact with an identification mechanism (e.g. touching the sensor with an id ring, or inserting a key or an id card). The detector 111 communicates the obtained information to the decision logic 113.

Sometimes the person or persons wanting access will not have on their person an appropriate identification device. For example, a person may forget to carry their id card or RFID device. The detector 111, device 102, sensor 114, and/or power control mechanism 104 may include a keypad or other user input mechanism so that the user may provide to the system authentication/identification or other information suitable for authorization. For example, a person could enter a password on a keypad, and the password could be applied to enable power transfer from the power source to the device 102.

The decision logic 113 may comprise logic to receive this information, which may include an identification of a party or parties that are proximate to one or more devices, and/or who have performed an action indicating they are interested in using one or more devices. Where a clear identification(s) is not received, the decision logic 113 may comprise logic to identify the person or persons based upon the obtained information. The decision logic 113 may comprise logic to receive, using wireless communication, one or more data busses, power line communication, and/or other network communication, the information and/or identifications of the one or more parties.

Identification/authorization of a party may comprise use of a look-up table and logic incorporated within the decision logic 113, and/or at least partially distinct from the decision logic 113, such as external logic and/or databases.

Identification of a party may comprise identification of a specific individual. Identification of a party may comprise identification that the party has a specific characteristic or belongs to a specific group (for example, is an adult or is a child, or a person having a particular security clearance). Identification of a party may comprise recognition that the party is not known (for example, is not an occupant of a residence).

The decision logic 113 may comprise logic to authorize one or more parties to access one or more devices. Logic to authorize a party may comprise logic to selectively provide capabilities to the party. For example, a party may be authorized to use the device 102 by enabling transmission of power to the plug 103 of the device 102; however, the party may not be authorized to unlock the device (enabling them to move it). A different party may be authorized to do both. In some embodiments, authorization information may be received from the detector 111 and/or sensor 114, along with authentication information. For example, a smart card or smart key inserted into the detector 111 and/or sensor 114 may provide information such as a user name and password, along with requested access rights.

In some embodiments, the device 102 may be powered on, and the party or parties may be authorized by the system to turn the power off.

The decision logic 113 may comprise logic to enable transmission of power from the power interface 115 to the power plug 103 in response to authorization of a party. The decision logic 113 may comprise logic to determine at least one devices and/or power sources proximate to one or more parties and/or belonging to a same logical group. For example, the decision logic 113 could identify plug 112 as the power source proximate to and/or serving device 102. The decision logic 113 may comprise logic to authorize one or more parties to operate at least one devices, for example by enabling the power sources (e.g. plug 112) for the at least one devices. In some embodiments, some or all features herein described as comprised by the power control mechanism 104 may be provided by the plug 112 providing the power source for the device, e.g. the plug 112 may be a “smart plug” enabling the featured described herein, without resort to a separate power control mechanism 104. The decision logic 113 may comprise logic to deny the party use of the device 102 by not enabling the transmission of power to the plug 103.

In one embodiment, a power source 112 comprises logic to selectively enable transmission of power from power lines to a plug 115, and/or lock/unlock the plug 115 to the power source 112, according to indications from decision logic 113.

As previously noted, the decision logic 113 may comprise logic to communicate via the power transmission path, or otherwise, indications that enable power to be transmitted from power sources 112 and/or power interfaces 115 to devices coupled to the power sources.

The power controlling mechanism 104 may comprise logic to receive, via the power transmission path, over a bus, or over a wired or wireless network, an indication that power should be transmitted from the power source to a coupled device.

In some embodiments, plugging a device 102 into a power source 112 or into a power control mechanism 104 results in association of the device 102 with the power source 112. The decision logic 113 receive via the power transmission path or by other means an indication/identification of the device 102, including for example identifications and/or information about people/attributes and/or authorization information for the people/attributes. The decision logic 113 may then selectively enable the power source according to the party or parties attempting access. For example, a computing device (personal computer, laptop computer, handheld device, and so on) may include information about those people who may use the device, and/or their authorizations. Plugging the computing device into an outlet may result in communication of this information to the decision logic 113. The computing device may also communicate information about itself to the decision logic 113. The decision logic may then selectively enable power to the outlet according to the person who is attempting to use the computing device.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices-described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. An apparatus comprising:
a receptacle to receive a power plug;
a lock to secure the power plug;
a power input; and
logic to selectively transfer power from the power input to the receptacle.

2. The apparatus of claim 1, further comprising:
logic to receive an indication via a power transmission path to enable transfer of power from the power input to the receptacle.

3. The apparatus of claim 1, further comprising:
logic to receive information about one or more parties;
logic to selectively authorize the one or more parties; and
logic to enable transmission of power from the power input to the receptacle in response to authorization of the one or more parties.

4. The apparatus of claim 1, further comprising:
logic to receive information about one or more parties; and
logic to communicate the party information via the power interface to decision logic, the decision logic providing an indication to the apparatus as to whether or not to enable the transmission of power from the power input to the receptacle.

5. A system comprising:
logic to receive information about one or more parties;
logic to communicate the information to decision logic via a power transmission path; and
logic to receive, via the power transmission path, one or more indications that power should be transmitted from one or more power sources to one or more devices coupled to the power sources.

6. The system of claim 5, further comprising:
a detector to detect the party information and to communicate the party information to the decision logic via a power transmission path.

7. The system of claim 5, the decision logic further comprising:
logic to determine at least one devices and/or power sources proximate to the one or more parties and/or belonging to a same group or groups and/or having one or more similar attributes;
logic to authorize the one or more parties to operate the at least one devices, or not; and
logic to cause power sources for the at least one devices to be enabled, or not, according to the authorizations

8. The system of claim 5, further comprising:
the decision logic comprising logic to communicate via the power transmission path indications that enable power to be transmitted from power sources to devices coupled to the power sources
